(19) United States
(12) Patent Application Publication
(10) Pub. No.: US 2023/0099520 A1
(43) Pub. Date: Mar. 30, 2023

(54) INFORMATION PROCESSING APPARATUS, INFORMATION PROCESSING SYSTEM, AND NON-TRANSITORY RECORDING MEDIUM

(71) Applicant: Baihain RIN, Kanagawa (JP)

(72) Inventor: Baihain RIN, Kanagawa (JP)

(21) Appl. No.: 17/949,214

(22) Filed: Sep. 21, 2022

(30) Foreign Application Priority Data
Sep. 28, 2021 (JP) 2021-158278

(51) Int. Cl. G06Q 50/18; G06F 40/106

(52) U.S. Cl. CPC G06Q 50/18; G06F 40/106

(57) ABSTRACT

An information processing apparatus includes circuitry to receive electronic data and a user setting relating to the electronic data from a user terminal and transmit information on a content of processing to be performed by another information processing apparatus and the electronic data via a network to the another information processing apparatus. The content of processing is determined based on the user setting.

### CROSS-REFERENCE TO RELATED APPLICATIONS

This patent application is based on and claims priority pursuant to 35 U.S.C. § 119(a) to Japanese Patent Application No. 2021-158278, filed on Sep. 28, 2021, in the Japan Patent Office, the entire disclosure of which is hereby incorporated by reference herein.

### BACKGROUND

### Technical Field

The present disclosure relates to an information processing apparatus, an information processing system, and a non-transitory recording medium.

### Related Art

A document management system for electronically managing electronic data such as documents generated in business is used. Also, an electronic contract system for electronically concluding a contract using electronic data is used. An information processing apparatus included in such a document management system manages the electronic data used for concluding the contract by another information processing apparatus included in such an electronic contract system in cooperation with each other.

For example, a document management system includes an information processing apparatus which switches document processing operations based on metadata added to an electronic document or electronic data.

### SUMMARY

In one aspect, an information processing apparatus includes circuitry to receive electronic data and a user setting relating to the electronic data from a user terminal and transmit information on a content of processing to be performed by another information processing apparatus and the electronic data via a network to the another information processing apparatus. The content of processing is determined based on the user setting.

In another aspect, an information processing system includes a first information processing apparatus and a second information processing apparatus to communicate with the first information processing apparatus via a network. The first information processing apparatus includes first circuitry to receive electronic data and a user setting relating to the electronic data from a user terminal and transmit information on a content of processing to be performed by the second information processing apparatus and the electronic data to the second information processing apparatus. The content of processing is determined based on the user setting. The second information processing apparatus includes second circuitry to receive the content of the processing and the electronic data transmitted from the first information processing apparatus and process the electronic data in accordance with the content of the processing.

In another aspect, a non-transitory recording medium storing a plurality of program codes which, when executed by one or more processors, causes the processors to perform a method. The method includes receiving electronic data and a user setting relating to the electronic data from a user terminal and transmitting information a content of processing to be performed by an information processing apparatus and the electronic data via a network to the information processing apparatus. The content of processing is determined based on the user setting.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an information processing system according to embodiments of the present disclosure;

FIG. 2 is a block diagram illustrating a hardware configuration of an information processing apparatus according to embodiments of the present disclosure;

FIG. 3 is a block diagram illustrating a hardware configuration of an image forming apparatus according to embodiments of the present disclosure:

FIG. 4 is a block diagram illustrating a functional configuration of a document management server according to a first embodiment of the present disclosure:

FIG. 5 is a block diagram illustrating a functional configuration of an electronic contract server according to the first embodiment of the present disclosure;

FIG. 6 is a block diagram illustrating a functional configuration of one of user terminals according to the first embodiment of the present disclosure;

FIG. 7 is a block diagram illustrating a functional configuration of a business partner terminal according to the first embodiment of the present disclosure,

FIG. 8 is a sequence chart illustrating a processing method (with automatic transmission) performed by an information processing system according to a comparative example;

FIG. 9 is a view illustrating an example of a browser according to one embodiment of the present disclosure:

FIG. 10 is a view illustrating an example of a workflow setting screen according to one embodiment of the present disclosure;

FIG. 11 is a table illustrating an example of a workflow information table according to one embodiment of the present disclosure;

FIG. 12 is a view illustrating an example of a document registration screen according to one embodiment of the present disclosure;

FIG. 13 is a view illustrating an example of a metadata setting screen according to the comparative example:

FIG. 14 is a table illustrating an example of a metadata table according to the comparative example;

FIG. 15 is a table illustrating an example of a destination information table according to one embodiment of the present disclosure;

FIG. 16 is a sequence chart illustrating a processing method (without automatic transmission) performed by the information processing system according to the comparative example;

FIG. 17 is a view illustrating an example of an optional function setting screen according to one embodiment of the present disclosure;

FIG. 18 is a table illustrating an example of an option information table according to one embodiment of the present disclosure;

FIG. 19 is a sequence chart illustrating a processing method performed by the information processing system according to the first embodiment of the present disclosure;

FIG. 20 is a sequence chart illustrating a processing method performed by the information processing system according to the first embodiment of the present disclosure:

FIG. 21 is a view illustrating an example of a metadata setting screen according to the first embodiment of the present disclosure;

FIG. 22 is a table illustrating an example of a metadata table according to the first embodiment of the present disclosure;

FIG. 23 is a block diagram illustrating a functional configuration of the document management server according to a second embodiment of the present disclosure;

FIG. 24 is a block diagram illustrating a functional configuration of one of the user terminals according to the second embodiment of the present disclosure;

FIG. 25 is a sequence chart illustrating a processing method performed by the information processing system according to the second embodiment of the present disclosure;

FIG. 26 is a view illustrating an example of a determination rule setting screen according to the second embodiment of the present disclosure:

FIG. 27 is a view illustrating a specific example of the determination rule setting screen according to the second embodiment of the present disclosure; and

FIG. 28 is a table illustrating an example of a determination rule information table according to the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described in detail with reference to the drawings. In the description of the drawings, the same elements are denoted by the same reference numerals, and redundant descriptions thereof are omitted.

Generally, a document management system is an information processing system for electronically storing, managing, and utilizing a document generated in business in a company or the like. Also, an electronic contract system is an information processing system for electronically concluding a contract in a company or the like.

Both the document management system and the electronic contract system are used in cooperation. In the cooperation between the document management system and the electronic contract system, a contract uploaded to the document management system is transmitted to the electronic contract system, and the contract is concluded with a counterparty of the contract using the electronic contract system. Thereafter, the contract concluded with the counterparty of the contract is transmitted to the document management system again and managed by the document management system.

The electronic contract system may have a function of executing various processing on the contract (hereinafter referred to as an “optional function”). Examples of the various processing include adding a comment to the contract, adding an indication (e.g., a seal or a signature) representing agreement, and designating a position where the indication is placed.

In the cooperation between the document management system and the electronic contract system, one of the following two operations is conventionally performed depending on whether the optional function is used. In a first operation, after the document is transmitted to the electronic contract system from the document management system, a user logs in to the electronic contract system, uses the optional function (e.g., designation of a position where a signature is placed), and manually transmits the document to a counterparty of the contract (hereinafter also referred to as a “business partner”). In a second operation, after the document is transmitted to the electronic contract system from the document management system, the document is automatically transmitted to the business partner without the optional function being performed.

However, in the conventional cooperation between the document management system and the electronic contract system, the above two operations are not automatically switched. In other words, in a case where the optional function is not used, the user still has to log in to the electronic contract system and manually transmit the document to the business partner after the document is transmitted to the electronic contract system from the document management system.

According to one embodiment of the present disclosure, control information representing the contents of processing is transmitted from the document management system to the electronic contract system together with the document. The electronic contract system determines whether to automatically transmit the document to the business partner or to manually transmit (by a user operation) the document to the business partner according to the control information received together with the document. As a result, in a case where the user does not use the optional function, the user can transmit the document to the business partner by operating only the document management system without operating the electronic contract system. In a case where the user uses the optional function, the user can manually transmit the document to the business partner after operating the electronic contract system.

### First Embodiment

According to a first embodiment of the present disclosure, metadata stored by a document management system in association with a document includes information representing whether an optional function is used in an electronic contract system. In other words, the information represents whether the document should be automatically transmitted to the business partner. Hereinafter, the information representing whether the optional function is used in the electronic contract system is also referred to as “control information (information on a content of processing)” and the processing in which the document is automatically transmitted is also referred to as “automatic transmission.” The electronic contract system receives the metadata together with the document from a document management server and controls the contents of processing on a contract according to the control information included in the metadata.

The document according to the present embodiment is electronic data representing the contents of the document or the like. The electronic data represents the contents of not only a document but also any information such as a text, an image, or a moving image.

Overall Configuration of Information Processing System

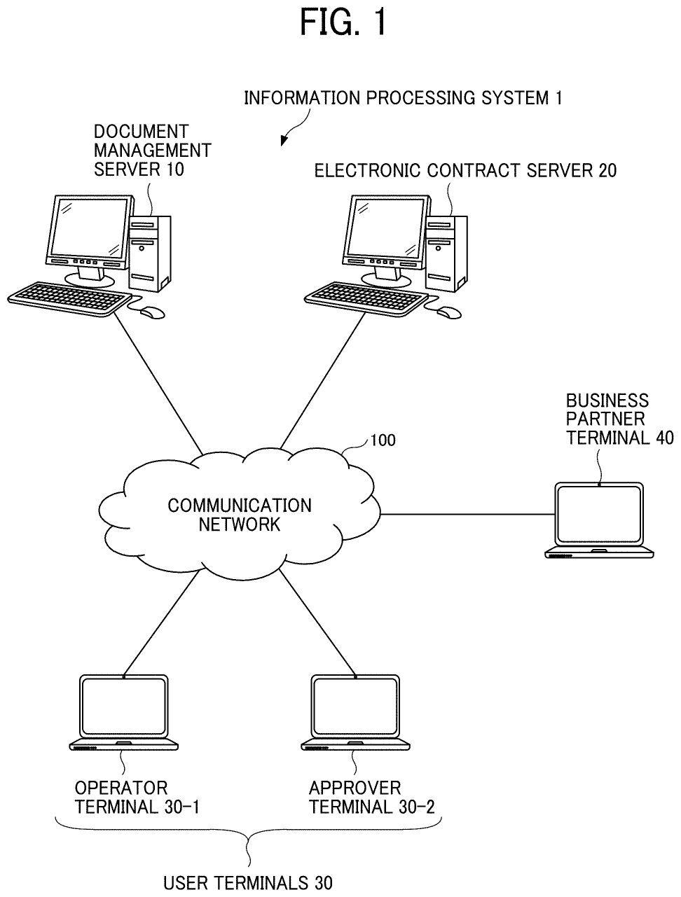

A description is given of an overall configuration of an information processing system 1 according to the present embodiment with reference to FIG. 1. FIG. 1 is a schematic diagram illustrating an example of the overall configuration of the information processing system 1 according to the present embodiment.

As illustrated in FIG. 1, the information processing system 1 includes a document management server 10, an electronic contract server 20, an operator terminal 30-1, an approver terminal 30-2, and a business partner terminal 40. The operator terminal 30-1 and the approver terminal 30-2 are classified according to the type of user, but have the same functions. Hereinafter, the operator terminal 30-1 and the approver terminal 30-2 are collectively referred to as user terminals 30, and one thereof is referred to as a user terminal 30.

The document management server 10, the electronic contract server 20, the user terminals 30, and the business partner terminal 40 are connected to a communication network 100. Each apparatus or device is communicably connected to one another via the communication network 100. The communication network 100 is implemented by a wired communication network such as the Internet, a local area network (LAN), a wide area network (WAN), or the like. The communication network 100 may include not only the wired communication network but also a wireless communication network such as a wireless LAN or a short-range wireless communication, or a mobile communication such as Worldwide Interoperability for Microwave Access (WiMAX), Long Term Evolution (LTE), or the fifth generation (5G).

The document management server 10 electronically manages a document generated in business.

The document management server 10 enables efficient retrieval of the document by storing metadata and the document in association with each other. In addition, the document management server 10 has a function of executing a workflow for doing business, and efficiently enables, for example, a document circulation flow.

The document management server 10 may be implemented by one information processing apparatus or may be a system implemented by a plurality of information processing apparatuses.

The electronic contract server 20 executes processing for electronically concluding a contract. The electronic contract server 20 transmits the contract to the business partner. In a case where the business partner agrees on the contract, the electronic contract server 20 executes processing of adding an electronic signature and a seal to the contract.

The electronic contract server 20 may be implemented by one information processing apparatus or may be a system implemented by a plurality of information processing apparatuses.

The user terminals 30 are electronic devices used by users. The users operate both the document management server 10 and the electronic contract server 20 by using the user terminals 30.

According to the present embodiment, the users include an operator who prepares the contract and an approver who examines and approves the contents of the contract. The operator terminal 30-1 is one of the user terminals 30 used by the operator. The approver terminal 30-2 is one of the user terminals 30 used by the approver.

The business partner terminal 40 is an electronic device used by a user at the business partner. The user at the business partner operates the electronic contract server 20 by using the business partner terminal 40.

Each example of the document management server 10, the electronic contract server 20, the user terminals 30, and the business partner terminal 40 is an information processing apparatus. Another example of each of the document management server 10, the electronic contract server 20, the user terminals 30, and the business partner terminal 40 is an image forming apparatus such as a printer, a facsimile machine, a digital multifunction peripheral/product/printer (MFP), or a scanner. Note that each of the document management server 10, the electronic contract server 20, the user terminals 30, and the business partner terminal 40 may be any information processing apparatus or image forming apparatus having a communication function.

Each of the document management server 10, the electronic contract server 20, the user terminals 30, and the business partner terminal 40 may be, for example, a projector, an interactive white board (IWB; an electronic white board having a blackboard function capable of mutual communication), an output device such as a digital signage, a head-up display (HUD) device, an industrial machine, an imaging device, a sound collecting device, a medical device, a network home appliance, an automobile (connected car), a laptop personal computer (PC), a mobile phone, a smartphone, a tablet terminal, a game console, a personal digital assistant (PDA), a digital camera, a wearable PC, or a desktop PC.

Hardware Configuration of Each Apparatus Included in Information Processing System

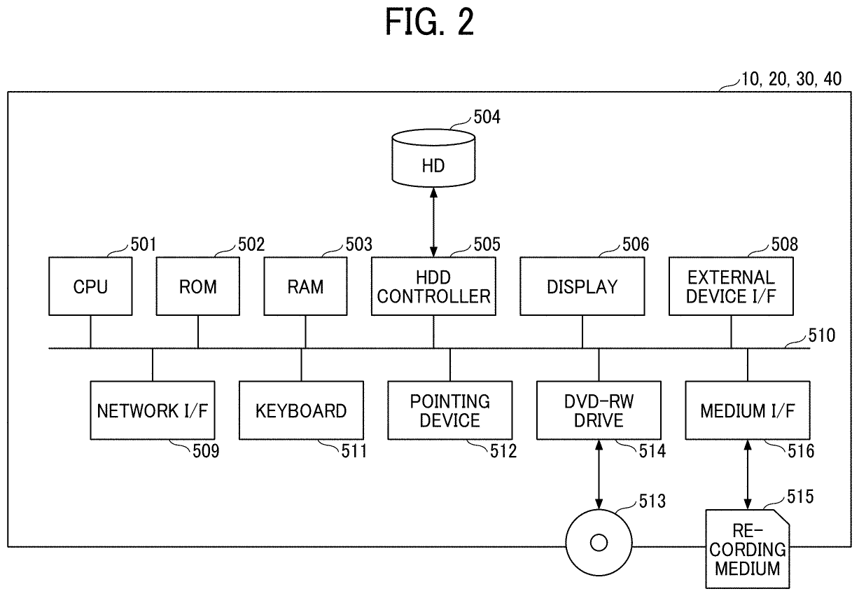

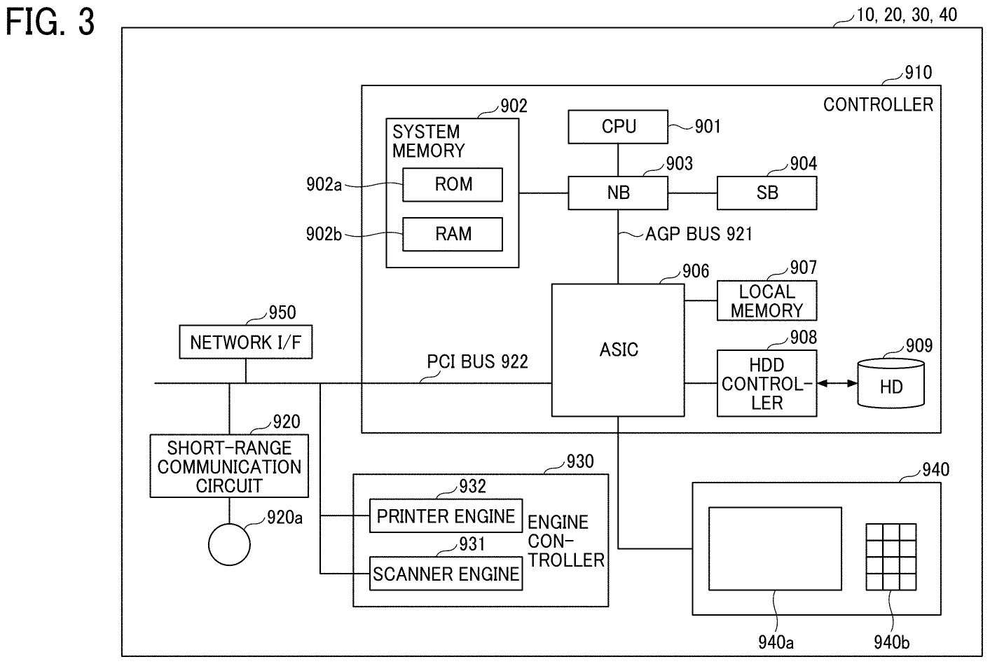

A description is given of a hardware configuration of each apparatus included in the information processing system 1 according to the present embodiment with reference to FIGS. 2 and 3.

Hardware Configuration of Information Processing Apparatus

FIG. 2 is a block diagram illustrating an example of a hardware configuration of an information processing apparatus in a case where each of the document management server 10, the electronic contract server 20, the user terminals 30, and the business partner terminal 40 is implemented as an information processing apparatus.

As illustrated in FIG. 2, the information processing apparatus includes a central processing unit (CPU) 501, a read only memory (ROM) 502, a random access memory (RAM) 503, a hard disk (HD) 504, a hard disk drive (HDD) controller 505, a display 506, an external device interface (I/F) 508, a network I/F 509, a data bus 510, a keyboard 511, a pointing device 512, a digital versatile disc rewritable (DVD-RW) drive 514, and a medium I/F 516.

The CPU 501 controls entire operation of the information processing apparatus. The ROM 502 stores a program such as an initial program loader (IPL) used for driving the CPU 501. The RAM 503 is used as a work area for the CPU 501. The HD 504 stores various data such as a program. The HDD controller 505 controls reading and writing of various data from and to the HD 504 under control of the CPU 501. The display 506 displays various information such as a cursor, a menu, a window, characters, and images. The external device I/F 508 is an interface for connection with various external devices. Examples of the external devices include, but not limited to, a universal serial bus (USB) memory and a printer. The network I/F 509 is an interface for data communication through the communication network 100. The data bus 510 is an address bus or a data bus, which electrically connects each component illustrated in FIG. 2 such as the CPU 501.

The keyboard 511 is an example of an input device including a plurality of keys for inputting characters, numerical values, various instructions, and the like. The pointing device 512 is an example of an input device that allows a user to select or execute various instructions, select an object for processing, and move a cursor being displayed. The DVD-RW drive 514 controls reading and writing of various data from and to a DVD-RW 513, which is an example of a removable storage medium. The removable storage medium is not limited to the DVD-RW and may be a digital versatile disc-recordable (DVD-R) or the like. The medium/F 516 controls reading and writing (storing) of data from and to a recording medium 515 such as a flash memory.

Hardware Configuration of Image Forming Apparatus

FIG. 3 is a block diagram illustrating an example of a hardware configuration of an image forming apparatus in a case where each of the document management server 10, the electronic contract server 20, the user terminals 30, and the business partner terminal 40 is implemented as an image forming apparatus.

As illustrated in FIG. 3, the image forming apparatus includes a controller 910, a short-range communication circuit 920, an engine controller 930, a control panel 940, and a network I/F 950.

The controller 910 includes a CPU 901 as a main processor, a system memory 902, a north bridge (NB) 903, a south bridge (SB) 904, an application specific integrated circuit (ASIC) 906, a local memory 907 as a storage area, an HDD controller 908, and an HD 909 as a storage area. The NB 903 and the ASIC 906 are connected via an accelerated graphics port (AGP) bus 921.

The CPU 901 controls entire operation of the image forming apparatus. The NB 903 is a bridge for connecting the CPU 901 with the system memory 902, the SB 904, and the AGP bus 921. The NB 903 includes a memory controller for controlling reading and writing of various data from and to the system memory 902, a peripheral component interconnect (PCI) master, and an AGP target.

The system memory 902 includes a ROM 902a as a memory that stores a program and data for implementing various functions of the controller 910. The system memory 902 further includes a RAM 902b used as a memory to load the program and the data, or as a drawing memory that stores drawing data for printing. The program stored in the ROM 902a may be stored in any computer-readable recording medium, such as a compact disc read only memory (CD-ROM), a compact disc recordable (CD-R), or a digital versatile disc (DVD), in a file format installable or executable by a computer, for distribution.

The SB 904 is a bridge for connecting the NB 903 to a PCI device and a peripheral device. The ASIC 906 is an integrated circuit (IC) for image processing applications including hardware elements for image processing and has a role of a bridge connecting the AGP bus 921, a PCI bus 922, the HDD controller 908, and the local memory 907 each other. The ASIC 906 includes a PCI target, an AGP master, an arbiter (ARB) as a central processor of the ASIC 906, a memory controller to control the local memory 907, a plurality of direct memory access controllers (DMACs), and a PCI unit. The DMACs rotate image data by converting coordinates of the image data with, for example, a hardware logic. The PCI unit transfers data between the scanner engine 931 and the printer engine 932 via the PCI bus 922. The ASIC 906 may be connected to a USB interface, the Institute of Electrical and Electronics Engineers 1394 (IEEE1394) interface, or both.

The local memory 907 is a local memory used as a copy image buffer and a code buffer. The HD 909 is a storage for storing image data, font data used during printing, and forms. The HDD controller 908 controls reading and writing of various data from and to the HD 909 under control of the CPU 901. The AGP bus 921 is a bus interface for a graphics accelerator card, which has been proposed to accelerate graphics processing. Through directly accessing the system memory 902 by high-throughput, speed of the graphics accelerator card is improved.

The short-range communication circuit 920 includes a short-range communication antenna 920a. The short-range communication circuit 920 is a communication circuit in compliance with the near field communication (NFC), BLUETOOTH, or the like.

The engine controller 930 includes the scanner engine 931 and the printer engine 932. The control panel 940 includes a panel display 940a and an operation panel 940b. The panel display 940a is, for example, a touch panel that displays current settings or a selection screen and receives a user input. The operation panel 940b includes, for example, a numeric keypad and a start key. The numeric keypad receives assigned values of image forming parameters such as an image density parameter. The start key receives an instruction to start copying, for example. The controller 910 controls entire operation of the image forming apparatus. For example, the controller 910 controls rendering, communication, and user inputs from the control panel 940. The scanner engine 931 or the printer engine 932 includes an image processing unit for error diffusion, gamma conversion, and the like.

The image forming apparatus may sequentially switch to select a document server function, a copying function, a printing function, and a facsimile communication function by an application switching key of the control panel 940. When the document server function is selected, a document server mode is set, when the copying function is selected, a copy mode is set, when the printing function is selected, a printer mode is set, and when the facsimile communication function is selected, a facsimile mode is set.

The network I/F 950 is an interface for data communication through the communication network 100. The short-range communication circuit 920 and the network IF 950 are electrically connected to the ASIC 906 via the PCI bus 922.

Functional Configuration of Each Apparatus Included in Information Processing System

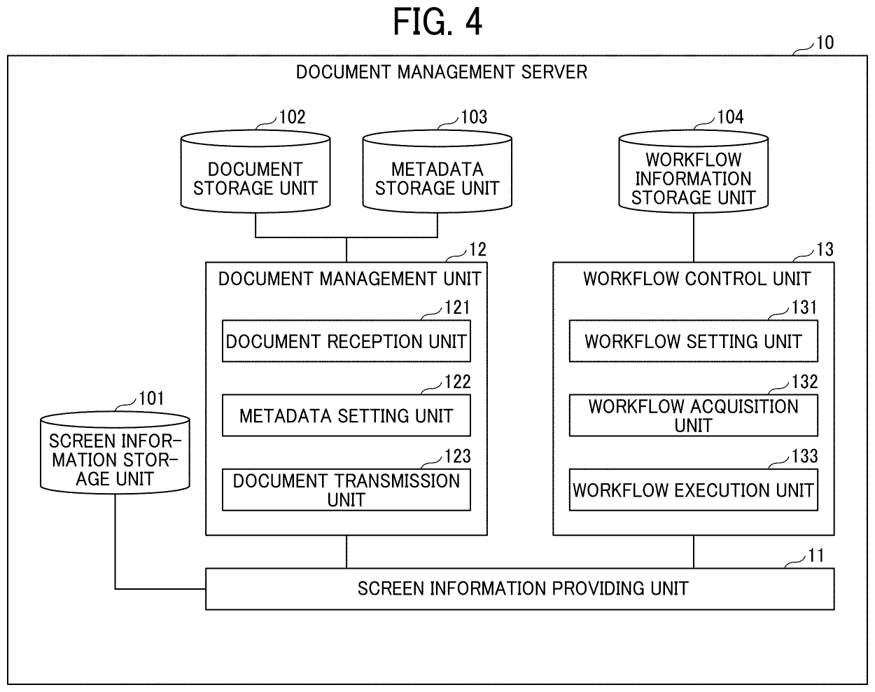

A description is given of a functional configuration of the information processing system 1 according to the present embodiment with reference to FIGS. 4 to 7.

Functional Configuration of Document Management Server

FIG. 4 is a block diagram illustrating an example of a functional configuration of the document management server 10 according to the preset embodiment. As illustrated in FIG. 4, the document management server 10 according to the present embodiment includes a screen information providing unit 11, a document management unit 12, a workflow control unit 13, a screen information storage unit 101, a document storage unit 102, a metadata storage unit 103, and a workflow information storage unit 104. The document management unit 12 includes a document reception unit 121, a metadata setting unit 122, and a document transmission unit 123. The workflow control unit 13 includes a workflow setting unit 131, a workflow acquisition unit 132, and a workflow execution unit 133.

The screen information providing unit 11, the document management unit 12, and the workflow control unit 13 included in the document management server 10 are implemented by, for example, the CPU 501 illustrated in FIG. 2 executing a program loaded to the RAM 503 from the HD 504.

The screen information storage unit 101, the document storage unit 102, the metadata storage unit 103, and the workflow information storage unit 104 included in the document management server 10 are implemented by using, for example, the HD 504 illustrated in FIG. 2. Reading and writing of data from and to the HD 504 is performed, for example, via the HDD controller 505.

In response to a request from a browser 31 included in the user terminal 30, the screen information providing unit 11 provides the browser 31 with screen information stored in the screen information storage unit 101. The screen information stored in the screen information storage unit 101 is information representing a screen for operating the document management server 10.

The document management unit 12 stores a document and metadata received from the user terminal 30, and executes processing on the document and the metadata according to a workflow executed by the workflow control unit 13.

The document reception unit 121 receives the document from the user terminal 30. Further, the document reception unit 121 stores the document received from the user terminal 30 in the document storage unit 102.

The metadata setting unit 122 receives the metadata from the user terminal 30. Further, the metadata setting unit 122 stores the metadata received from the user terminal 30 in the metadata storage unit 103 in association with the document stored in the document storage unit 102.

The metadata includes one or more items of attribute information representing the contents of the document. The metadata is managed separately from a body of the document. Accordingly, adding or deleting an item of the metadata, or editing such as a change of a value of the metadata does not affect the body of the document.

In response to a request from the workflow control unit 13, the document transmission unit 123 transmits the document relating to the contract stored in the document storage unit 102 and the metadata stored in the metadata storage unit 103 in association with the document to the electronic contract server 20.

The workflow control unit 13 sets, acquires, and executes the workflow describing the contents of processing on the document.

The workflow setting unit 131 receives workflow information from the user terminal 30. Further, the workflow setting unit 131 stores the workflow information received from the user terminal 30 in the workflow information storage unit 104.

The workflow acquisition unit 132 acquires the workflow information stored in the workflow information storage unit 104.

The workflow execution unit 133 executes the workflow in accordance with the workflow information acquired by the workflow acquisition unit 132. The workflow execution unit 133 specifies a task to be performed next on the document and assigns the task to a user who should process the task. Further, the workflow execution unit 133 executes the processing on the document in response to an operation by the user. The processing on the document includes processing to be executed in cooperation with an external system.

The screen information storage unit 101 stores the screen information which the screen information providing unit 11 provides the browser 31 with. Each piece of the screen information stored in the screen information storage unit 101 is described in, for example, hypertext markup language (HTML), and may include an application described in JAVASCRIPT or the like.

The document storage unit 102 stores the document managed by the document management unit 12. The document stored in the document storage unit 102 is a body of an electronic file representing the contents of the document. The document is stored in the document storage unit 102 in a file format corresponding to a file system of the document storage unit 102.

The metadata storage unit 103 stores the metadata associated with the document managed by the document management unit 12. The metadata is stored in a metadata table stored in the metadata storage unit 103.

The workflow information storage unit 104 stores the workflow information on the workflow to be executed by the workflow control unit 13. The workflow information may be described in an electronic file in text format or may be stored in a table in a database.

Functional Configuration of Electronic Contract Server

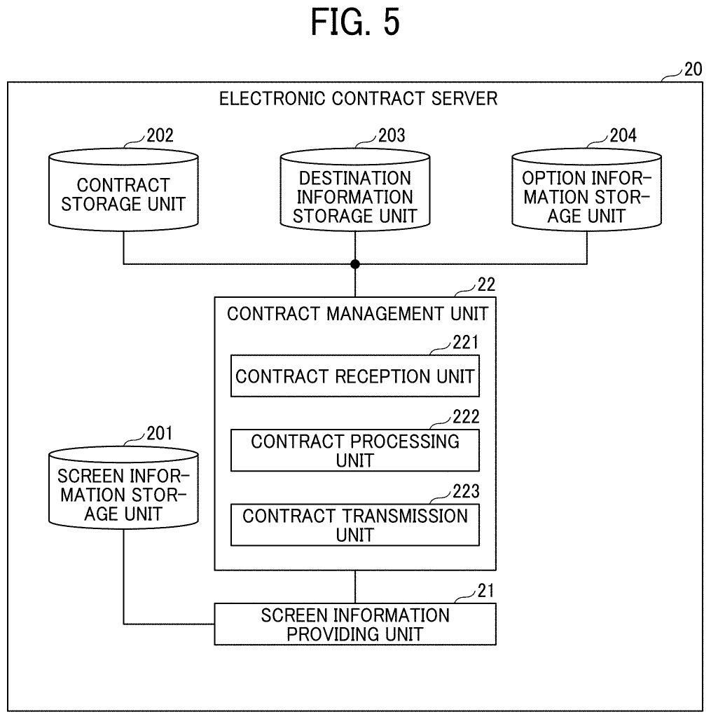

FIG. 5 is a block diagram illustrating an example of a functional configuration of the electronic contract server 20 according to the present embodiment. As illustrated in FIG. 5, the electronic contract server 20 according to the present embodiment includes a screen information providing unit 21, a contract management unit 22, a screen information storage unit 201, a contract storage unit 202, a destination information storage unit 203, and an option information storage unit 204. The contract management unit 22 includes a contract reception unit 221, a contract processing unit 222, and a contract transmission unit 223.

The screen information providing unit 21 and the contract management unit 22 included in the electronic contract server 20 are implemented by, for example, the CPU 501 illustrated in FIG. 2 executing a program loaded to the RAM 503 from the HD 504.

The screen information storage unit 201, the contract storage unit 202, the destination information storage unit 203, and the option information storage unit 204 included in the electronic contract server 20 are implemented by using, for example, the HD 504 illustrated in FIG. 2. Reading and writing of data from and to the HD 504 is performed, for example, via the HDD controller 505.

In response to a request from the browser 31 included in the user terminal 30 or a browser 41 included in the business partner terminal 40, the screen information providing unit 21 provides the browser 31 or the browser 41 with screen information stored in the screen information storage unit 201. The screen information stored in the screen information storage unit 201 is information representing a screen for operating the electronic contract server 20.

The contract management unit 22 stores the document relating to the contract received from the document management server 10, and executes processing on the contract in response to a request from the user terminal 30 or the business partner terminal 40.

The contract reception unit 221 receives the document relating to the contract and the metadata from the document management server 10. In addition, the contract reception unit 221 stores the document relating to the contract received from the document management server 10 in the contract storage unit 202. Further, the contract reception unit 221 stores destination information set in the metadata received from the document management server 10 in the destination information storage unit 203.

The contract processing unit 222 executes processing on the document relating to the contract stored in the contract storage unit 202. The processing executed by the contract processing unit 222 includes processing of executing an optional function.

The contract transmission unit 223 transmits the document relating to the contract stored in the contract storage unit 202 to the business partner terminal 40.

The screen information storage unit 201 stores screen information which the screen information providing unit 21 provides the browser 31 or the browser 41 with.

The contract storage unit 202 stores the document relating to the contract managed by the contract management unit 22. The document stored in the contract storage unit 202 is a body of an electronic file representing the contents of the document relating to the contract. The document relating to the contract is stored in the contract storage unit 202 in a file format corresponding to a file system of the contract storage unit 202.

The destination information storage unit 203 stores the destination information indicating a destination to which the document relating to the contract managed by the contract management unit 22 is transmitted. The destination information is stored in a destination information table stored in the destination information storage unit 203.

The option information storage unit 204 stores option information representing the setting contents of the optional function executed by the contract processing unit 222. The option information is stored in an option information table stored in the option information storage unit 204.

Functional Configuration of User Terminal

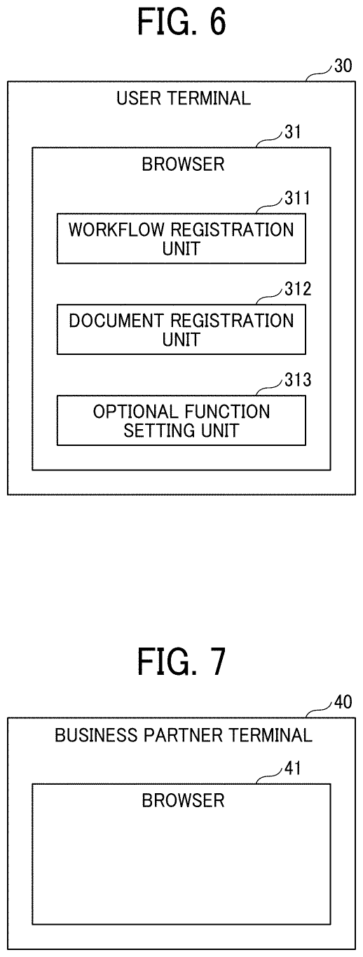

FIG. 6 is a block diagram illustrating an example of a functional configuration of the user terminal 30 according to the present embodiment.

As illustrated in FIG. 6, the user terminal 30 according to the present embodiment includes the browser 31. The browser 31 includes a workflow registration unit 311, a document registration unit 312, and an optional function setting unit 313.

The browser 31 included in the user terminal 30 is implemented by, for example, the CPU 501 illustrated in FIG. 2 executing a program loaded to the RAM 503 from the HD 504.

The browser 31 requests screen information from the screen information providing unit 11 included in the document management server 10, and displays a screen for operating the document management server 10 based on the screen information received from the screen information providing unit 11. Also, the browser 31 requests screen information from the screen information providing unit 21 included in the electronic contract server 20, and displays a screen for operating the electronic contract server 20 based on the screen information received from the screen information providing unit 21.

The workflow registration unit 311 and the document registration unit 312 are implemented by the browser 31 executing the screen information received from the screen information providing unit 11. Also, the optional function setting unit 313 is implemented by the browser 31 executing the screen information received from the screen information providing unit 21.

The workflow registration unit 311 transmits a request for setting workflow information to the document management server 10 in response to a user operation on a workflow setting screen. The workflow setting screen is a screen for inputting the workflow information to be registered in the document management server 10. Details of the workflow setting screen are described later.

The document registration unit 312 transmits a request for registering a document to the document management server 10 in response to a user operation on a document registration screen. The document registration screen is a screen for inputting the document to be registered in the document management server 10. Details of the document registration screen are described later.

In addition, the document registration unit 312 transmits a request for setting metadata for the document to the document management server 10 in response to a user operation on a metadata setting screen. The metadata setting screen is a screen for inputting the metadata to be set for the document. Details of the metadata setting screen are described later.

The optional function setting unit 313 transmits a request for setting an optional function for the contract to the electronic contract server 20 in response to a user operation on an optional function setting screen. The optional function setting screen is a screen for inputting the setting contents of the optional function for the contract. Details of the optional function setting screen are described later.

Functional Configuration of Business Partner Terminal

FIG. 7 is a block diagram illustrating an example of a functional configuration of the business partner terminal 40 according to the present embodiment.

As illustrated in FIG. 7, the business partner terminal 40 according to the present embodiment includes the browser 41.

The browser 41 included in the business partner terminal 40 is implemented by, for example, the CPU 501 illustrated in FIG. 2 executing a program loaded to the RAM 503 from the HD 504.

The browser 41 requests screen information from the screen information providing unit 21 included in the electronic contract server 20, and displays a screen for operating the electronic contract server 20 based on the screen information received from the screen information providing unit 21.

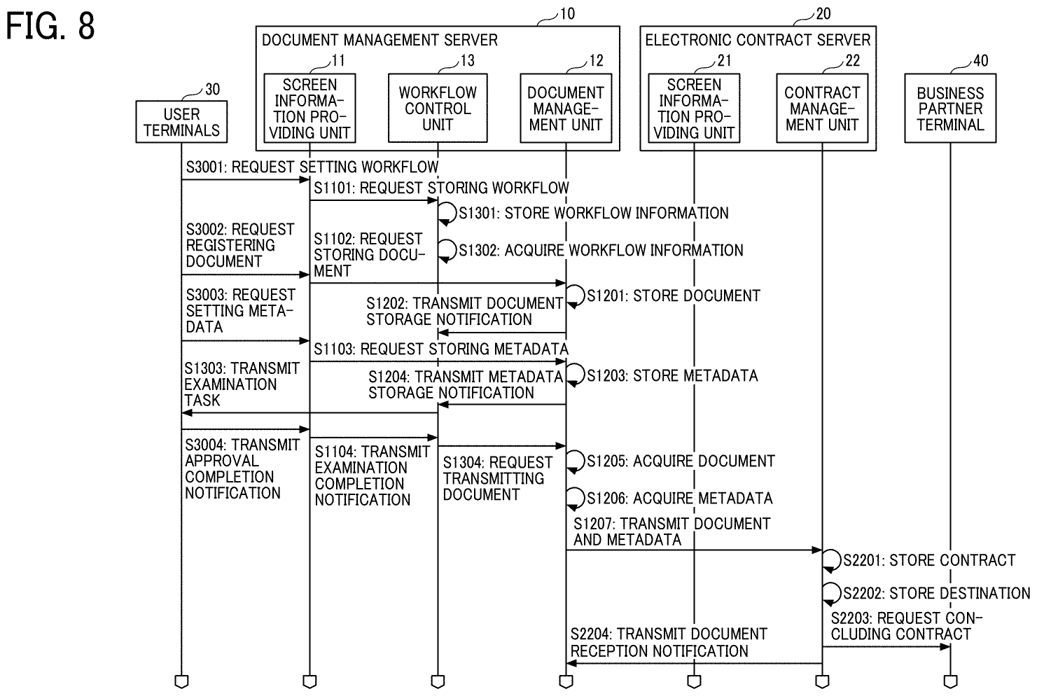

A description is given of an example of an information processing method according to a comparative example executed by the information processing system 1 with reference to FIG. 8. FIG. 8 is a sequence chart illustrating the information processing method when the automatic transmission is performed according to the comparative example.

In S3001, the browser 31 included in the user terminal 30 requests a workflow setting screen (specifically, screen information representing thereof) from the screen information providing unit 11 in response to a user operation. The screen information providing unit 11 transmits screen information representing the workflow setting screen stored in the screen information storage unit 101 to the browser 31. The browser 31 displays the workflow setting screen based on the screen information received from the screen information providing unit 11. As a result, the workflow registration unit 311 is activated.

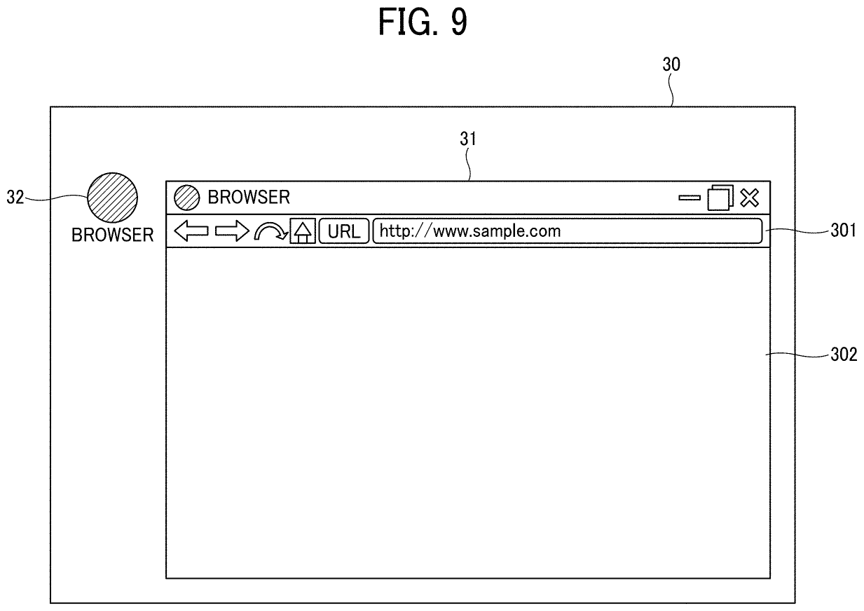

Here, a description is given of the browser 31 in detail with reference to FIG. 9. FIG. 9 is a view illustrating an example of the browser 31 according to the present embodiment.

As illustrated in FIG. 9, the browser 31 according to the present embodiment is activated by a user operating, for example, a shortcut button 32 arranged on a desktop of the user terminal 30. The browser 31 according to the present embodiment includes a uniform resource locator (URL) input field 301 and a screen display field 302.

When the user inputs a URL indicating a position in the document management server 10 to the URL input field 301, the browser 31 requests screen information from the screen information providing unit 11 included in the document management server 10. When the user inputs a URL indicating a position in the electronic contract server 20 to the URL input field 301, the browser 31 requests screen information from the screen information providing unit 21 included in the electronic contract server 20.

In response to receiving the screen information from the screen information providing unit 11 or the screen information providing unit 21, the browser 31 renders a screen on the screen display field 302 based on the screen information. The screen to be rendered may include a character, a figure, an image, or a moving image.

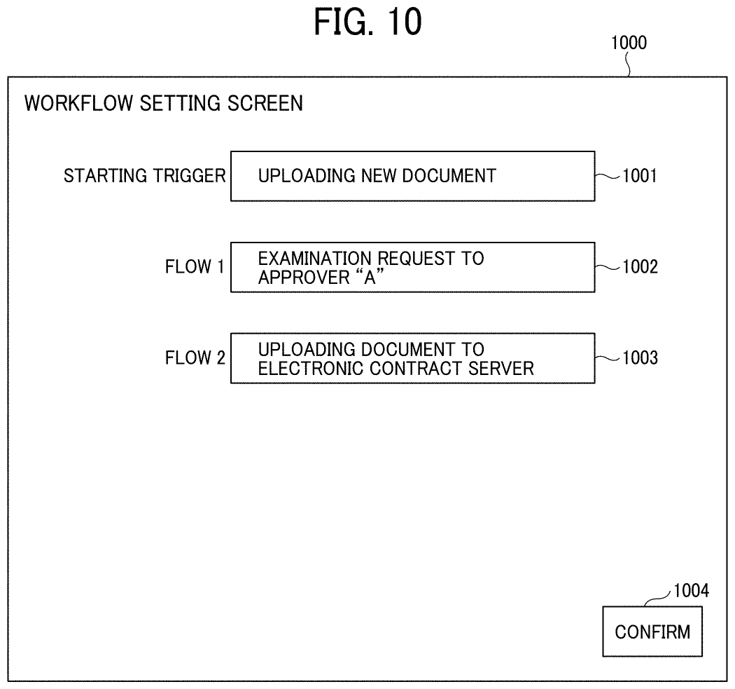

Here, a description is given of the workflow setting screen in detail with reference to FIG. 10. FIG. 10 is a view illustrating an example of a workflow setting screen 1000 according to the present embodiment.

As illustrated in FIG. 10, the workflow setting screen 1000 includes a starting trigger input field 1001, a flow 1 input field 1002, a flow 2 input field 1003, and a confirm button 1004.

The starting trigger input field 1001 receives an input of information representing a trigger to start a workflow. The flow 1 input field 1002 receives an input of information representing a process to be executed first in the workflow. The flow 2 input field 1003 receives an input of information representing a process to be executed after the process input to the flow 1 input field 1002 is completed.

When the user presses the confirm button 1004, the workflow registration unit 311 transmits a request for setting workflow information to the screen information providing unit 11. The request for setting the workflow information indicates the contents input to the starting trigger input field 1001, the flow 1 input field 1002, and the flow 2 input field 1003.

The user can add an input field in the workflow setting screen 1000, and change and delete each input field included in the workflow setting screen 1000 as desired in accordance with the contents that the user desires to set in the workflow. The user can set the number of processes included in the workflow as desired.

The structure of the workflow setting screen is not limited to the structure of the workflow setting screen 1000 illustrated in FIG. 10. For example, an intuitive display format such as a flowchart may be employed.

Returning to FIG. 8, the description continues. In S1101, the screen information providing unit 11 receives the request for setting the workflow information from the workflow registration unit 311. Then, the screen information providing unit 11 transmits a request for storing the workflow information to the workflow control unit 13 in response to the request for setting the workflow information.

In S1301, the workflow setting unit 131 included in the workflow control unit 13 receives the request for storing the workflow information from the screen information providing unit 11. Then, the workflow setting unit 131 stores the workflow information in the workflow information storage unit 104 in response to the request for storing the workflow information.

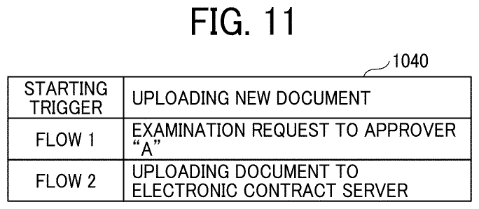

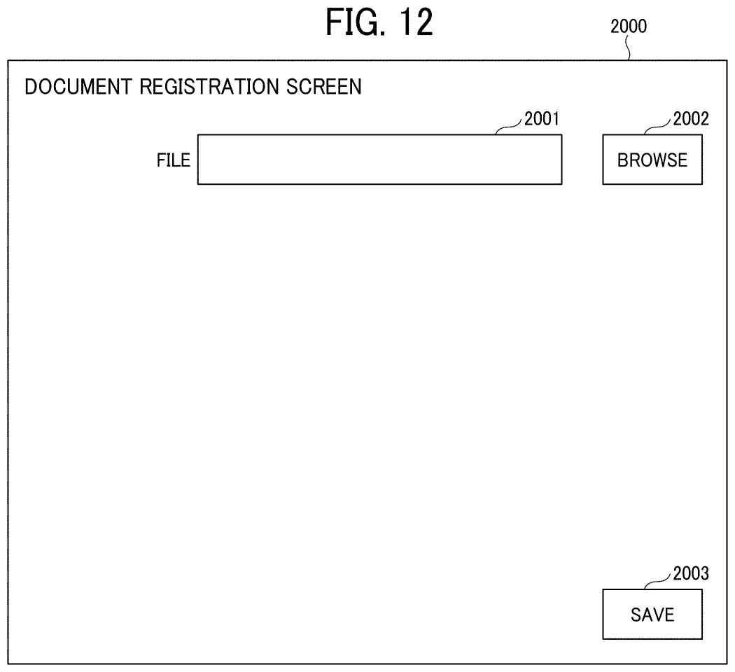

Here, a description is given of the workflow information stored in the workflow information storage unit 104 in detail with reference to FIG. 11. FIG. 11 is a table illustrating an example of a workflow information table 1040 according to the present embodiment.

As illustrated in FIG. 11, the workflow information table 1040 according to the present embodiment includes, as data items, “STARTING TRIGGER,” “FLOW 1V” and “FLOW 2.” The content input to the starting trigger input field 1001 is set as the value of the data item “STARTING TRIGGER.” The content input to the flow 1 input field 1002 is set as the value of the data item “FLOW L.” The content input to the flow 2 input field 1003 is set as the value of the data item “FLOW 2.”

Returning to FIG. 8, the description continues. In S1302, the workflow acquisition unit 132 included in the workflow control unit 13 acquires the workflow information stored in the workflow information storage unit 104.

In S3002, the browser 31 included in the operator terminal 30-1 requests a document registration screen from the screen information providing unit 11 in response to an operation by the operator. The screen information providing unit 11 transmits screen information representing the document registration screen stored in the screen information storage unit 101 to the browser 31. The browser 31 displays the document registration screen based on the screen information received from the screen information providing unit 11. As a result, the document registration unit 312 is activated.

Here, a description is given of the document registration screen in detail with reference to FIG. 12. FIG. 12 is a view illustrating an example of a document registration screen 2000 according to the present embodiment.

As illustrated in FIG. 12, the document registration screen 2000 includes a file input field 2001, a browse button 2002, and a save button 2003. The file input field 2001 receives an input of information indicating a location of an electronic file corresponding to a document to be registered. The information indicating the location of the electronic file may be an absolute path, a relative path, or information described in a uniform resource identifier (URI) format indicating a file on another apparatus.

When the user presses the browse button 2002, a dialog for selecting a file starts. The user performs an input to the file input field 2001 by selecting a file using the dialog for selecting a file.

When the user presses the save button 2003, the document registration unit 312 transmits a request for registering a document specified by the contents input to the file input field 2001 to the screen information providing unit 11.

Returning to FIG. 8, the description continues. In S1102, the screen information providing unit 11 receives the request for registering the document from the document registration unit 312. Then, the screen information providing unit 11 transmits a request for storing the document to the document management unit 12 in response to the request for registering the document.

In S1201, the document reception unit 121 included in the document management unit 12 receives the request for storing the document from the screen information providing unit 11. Then, the document reception unit 121 stores the document in the document storage unit 102 in response to the request for storing the document. At this time, the document storage unit 102 generates a document identifier (ID) for identifying the document.

In S1202, the document reception unit 121 transmits a document storage notification indicating completion of storage of the document to the workflow control unit 13. The document storage notification includes the document ID.

In S3003, the document registration unit 312 selects one document from documents stored in the document storage unit 102 in response to an operation by the operator. Then, the document registration unit 312 requests a metadata setting screen for setting metadata for the document from the screen information providing unit 11. The screen information providing unit 11 transmits screen information representing the metadata setting screen stored in the screen information storage unit 101 to the browser 31. The browser 31 displays the metadata setting screen based on the screen information received from the screen information providing unit 11.

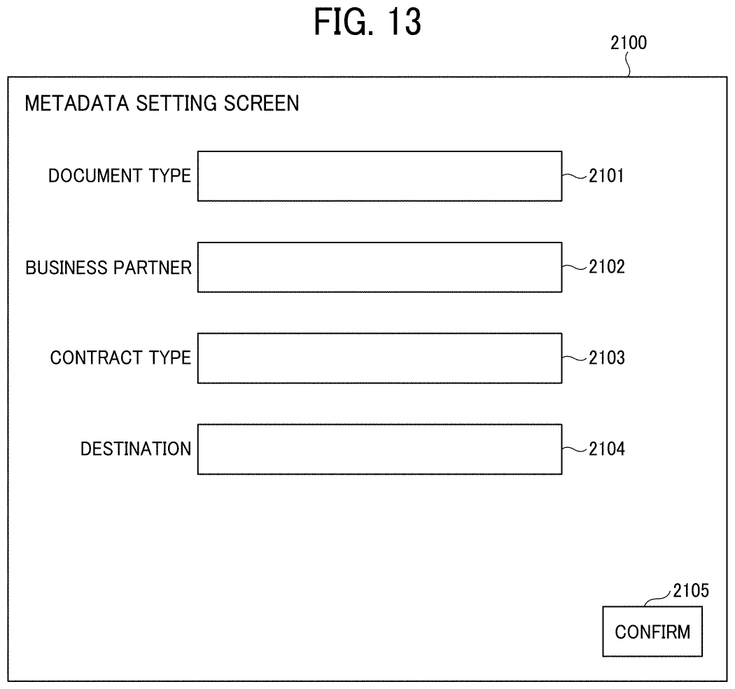

Here, a description is given of the metadata setting screen in detail with reference to FIG. 13. FIG. 13 is a view illustrating an example of a metadata setting screen 2100 according to the comparative example.

As illustrated in FIG. 13, the metadata setting screen 2100 includes a document type input field 2101, a business partner input field 2102, a contract type input field 2103, a destination input field 2104, and a confirm button 2105.

The document type input field 2101 receives an input of attribute information indicating the type of document. The business partner input field 2102 receives an input of attribute information indicating a business partner to which the document is to be sent. The contract type input field 2103 receives an input of attribute information indicating the type of contract in a case where the type of document is a contract. The destination input field 2104 receives an input of attribute information indicating a destination to which the contract is to be sent in a case where the type of document is a contract.

When the user presses the confirm button 2105, the document registration unit 312 transmits a request for setting metadata to the screen information providing unit 11. The request for setting metadata indicates the contents input to the document type input field 2101, the business partner input field 2102, the contract type input field 2103, and the destination input field 2104.

The user can add an input field in the metadata setting screen 2100, and change and delete each input field included in the metadata setting screen 2100 as desired in accordance with the contents that the user desires to set in the metadata. An input field corresponding to an item not set in the metadata may be left blank.

Returning to FIG. 8, the description continues. In SI 103, the screen information providing unit 11 receives the request for setting the metadata from the document registration unit 312. Then, the screen information providing unit 11 transmits a request for storing the metadata to the document management unit 12 in response to the request for setting the metadata. The request for storing the metadata includes the document ID.

In S1203, the metadata setting unit 122 included in the document management unit 12 receives the request for storing the metadata from the screen information providing unit 11. Then, the metadata setting unit 122 stores the metadata in the metadata storage unit 103 in response to the request for storing the metadata.

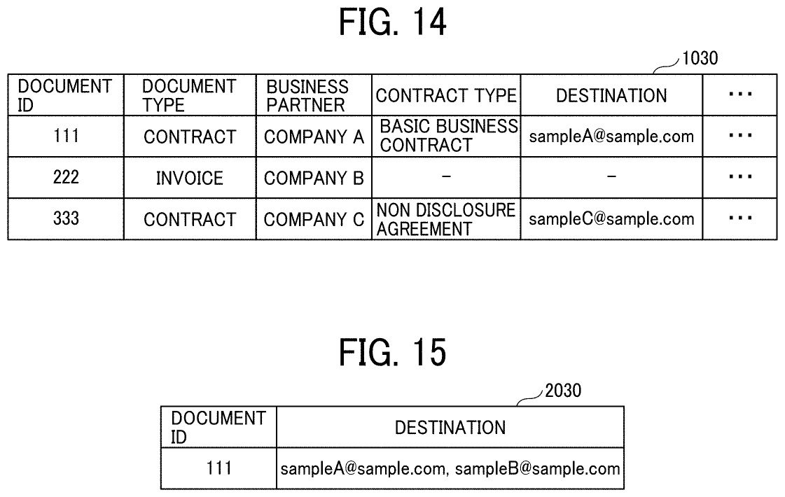

Here, a description is given of the metadata table stored in the metadata storage unit 103 in detail with reference to FIG. 14. FIG. 14 is a table illustrating an example of a metadata table 1030 according to the comparative example.

As illustrated in FIG. 14, the metadata table 1030 includes, as data items, “DOCUMENT ID,” “DOCUMENT TYPE,” “BUSINESS PARTNER.” “CONTRACT TYPE.” and “DESTINATION.”

The document ID is identification information for identifying the document in the document management server 10. In other words, the metadata is associated with the document by the document ID.

The content input to the document type input field 2101 is set as the value of the data item “DOCUMENT TYPE.” The content input to the business partner input field 2102 is set as the value of the data item “BUSINESS PARTNER.” The content input to the contract type input field 2103 is set as the value of the data item “CONTRACT TYPE.” The content input to the destination input field 2104 is set as the value of the data item “DESTINATION.”

The user can add a data item and delete a data item in the metadata table 1030 as desired in accordance with the type of document. Values may not be set for some data items depending on the type of document. For example, no values are set in the contract type and the destination of the document indicated by the document ID “222” in the metadata table 1030 illustrated in FIG. 14 since the type of the document is not a contract.

Returning to FIG. 8, the description continues. In S1204, the metadata setting unit 122 transmits a metadata storage notification indicating completion of storage of the metadata to the workflow control unit 13. The metadata storage notification includes the document ID.

In S1303, the workflow execution unit 133 included in the workflow control unit 13 transmits an examination task for requesting the approver to examine the document to the approver terminal 30-2 according to the workflow information acquired by the workflow acquisition unit 132. The examination task includes the document ID.

In S3004, the browser 31 included in the approver terminal 30-2 receives the examination task. The browser 31 displays the contents of the document specified by the document ID included in the examination task. The approver examines the contents of the document on the browser 31. When completing the examination, the approver performs an operation for approval on the browser 31. The browser 31 transmits an approval completion notification of the document to the screen information providing unit 11 in response to the operation by the approver.

In S1104, the screen information providing unit 11 receives the approval completion notification of the document from the approver terminal 30-2. Then, the screen information providing unit 11 transmits an examination completion notification to the workflow control unit 13 in response to the approval completion notification of the document. The examination completion notification includes the document ID.

In S1304, the workflow execution unit 133 included in the workflow control unit 13 receives the examination completion notification from the screen information providing unit 11. Then, the workflow execution unit 133 transmits a request for transmitting the document specified by the document ID included in the examination completion notification to the document management unit 12. The request for transmitting the document includes the document ID.

In S1205, the document transmission unit 123 included in the document management unit 12 receives the request for transmitting the document from the workflow execution unit 133. Then, the document transmission unit 123 acquires the document specified by the document ID included in the request for transmitting the document from the document storage unit 102.

In S1206, the document transmission unit 123 acquires metadata associated with the document specified by the document ID included in the request for transmitting the document from the metadata storage unit 103.

In S1207, the document transmission unit 123 transmits the document acquired in S1205 and the metadata acquired in S1206 as a pair to the electronic contract server 20.

In S2201, the contract reception unit 221 included in the electronic contract server 20 receives the document relating to the contract and the metadata from the document transmission unit 123. Then, the contract reception unit 221 stores the document relating to the contract in the contract storage unit 202.

In S2202, the contract reception unit 221 determines the destination included in the metadata received from the document transmission unit 123 to be a destination of the document relating to the contract stored in the contract storage unit 202. Then, the contract reception unit 221 stores destination information indicating the destination of the document relating to the contract in the destination information storage unit 203.

Here, a description is given of the destination information table stored in the destination information storage unit 203 in detail with reference to FIG. 15. FIG. 15 is a table illustrating an example of a destination information table 2030 according to the present embodiment.

As illustrated in FIG. 15, the destination information table 2030 according to the present embodiment includes “DOCUMENT ID” and “DESTINATION” as data items. The document ID and the destination set in the metadata received from the document management server 10 are set as the values of the data items “DOCUMENT ID” and “DESTINATION” respectively. The destination may include a plurality of destinations. When the plurality of destinations is set, a certain symbol such as a comma may be used as a delimiter.

Although e-mail addresses are used as destinations in the destination information table 2030 illustrated in FIG. 15, the destinations are not limited thereto. For example, any destination of communication methods, such as a telephone number, a facsimile number, or accounts of various types of social networking service (SNS), through which a document is electronically transmitted may be set as a destination.

Returning to FIG. 8, the description continues. In S2203, the contract transmission unit 223 included in the contract management unit 22 transmits a request for concluding the contract to the business partner terminal 40. The request for concluding the contract includes identification information indicating a location of the document relating to the contract stored in the electronic contract server 20. The identification information indicating the location is, for example, a URL that specifies the location of the document in an electronic space.

The business partner terminal 40 receives the request for concluding the contract from the electronic contract server 20. The business partner terminal 40 displays the document relating to the contract on the browser 41 based on the identification information of the contract included in the request for concluding the contract in response to an operation by the user at the business partner.

In S2204, the contract transmission unit 223 transmits a document reception notification indicating completion of reception of the document relating to the contract to the document management unit 12.

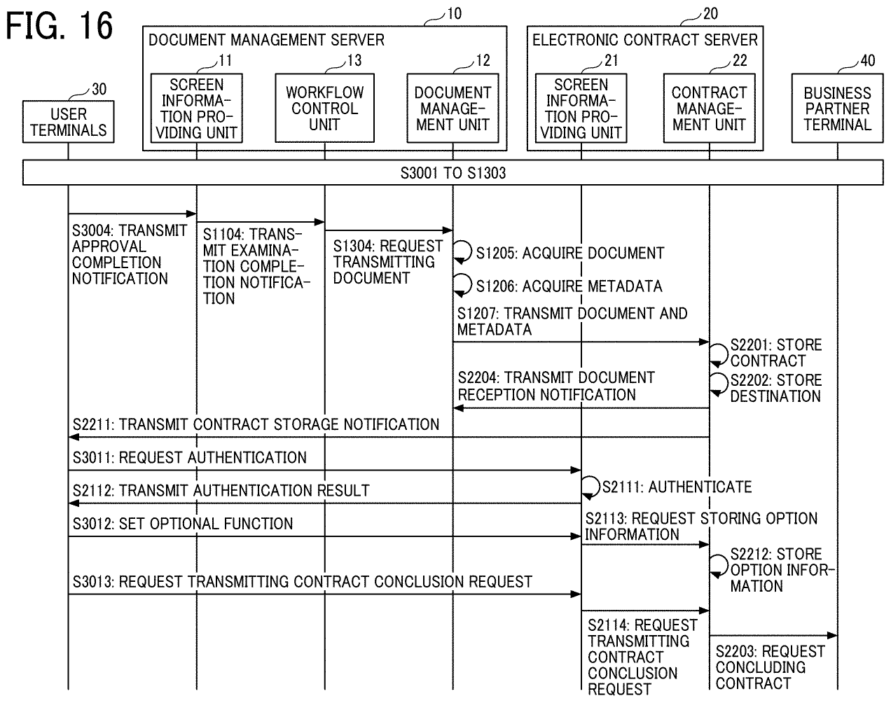

A description is given of an example of an information processing method according to the comparative example executed by the information processing system 1 with reference to FIG. 16. FIG. 16 is a sequence chart illustrating the information processing method when the automatic transmission is not performed according to the comparative example.

The processing of S3001 to S2202 is the same as the processing when the automatic transmission is performed (illustrated in FIG. 8).

In S2204, the contract transmission unit 223 transmits the document reception notification indicating completion of reception of the document relating to the contract to the document management unit 12.

Note that, according to the processing method when the automatic transmission is performed (illustrated in FIG. 8), the processing of S2204 is executed after the request for concluding the contract is transmitted in S2203. However, the processing of S2204 is executed before the processing of S2203 in a case where the automatic transmission is not performed. In the case where the automatic transmission is not performed, the request for concluding the contract needs to be manually transmitted. For this reason, the document reception notification indicating completion of reception of the document needs to be transmitted before the request for concluding the contract is manually transmitted.

In S2211, the contract processing unit 222 included in the contract management unit 22 transmits a contract storage notification indicating completion of storage of the contract to the operator terminal 30-1. The contract storage notification includes information for identifying the contract. The information for identifying the contract is, for example, the document ID that identifies the document relating to the contract or the URL that indicates the location of the document relating to the contract.

In S3011, the browser 31 included in the operator terminal 30-1 transmits a request for authentication to the electronic contract server 20. The request for authentication includes authentication information on the operator. Examples of the authentication information are a user ID for identifying the user (the operator) of the operator terminal 30-1 and a password input by the user.

In S2111, the screen information providing unit 21 receives the request for authentication from the browser 31. The screen information providing unit 21 authenticates the operator based on the authentication information included in the request for authentication.

In S2112, the screen information providing unit 21 transmits screen information representing a screen to be displayed after the authentication based on an authentication result for the operator to the browser 31. In the following description, it is assumed that the screen information providing unit 21 successfully authenticates the operator.

In S3012, the browser 31 included in the operator terminal 30-1 requests an optional function setting screen from the screen information providing unit 21 in response to an operation by the operator. The screen information providing unit 21 transmits screen information representing the optional function setting screen stored in the screen information storage unit 201 to the browser 31. The browser 31 displays the optional function setting screen based on the screen information received from the screen information providing unit 21. As a result, the optional function setting unit 313 is activated.

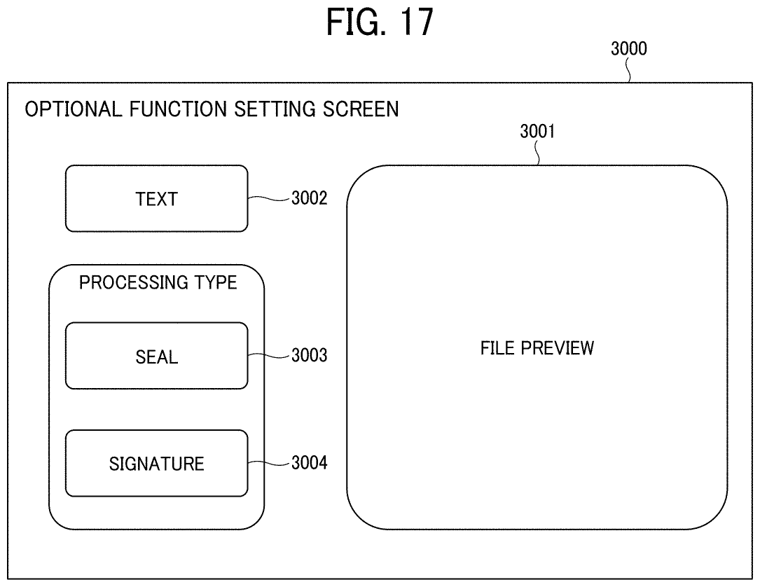

Here, a description is given of the optional function setting screen in detail with reference to FIG. 17. FIG. 17 is a view illustrating an example of an optional function setting screen 3000 for designating a position where a signature or a seal is placed according to the present embodiment.

Note that the structure of the optional function setting screen varies depending on the contents of the processing of an optional function. In the example of the present embodiment, processing of adding a comment and adding an indication representing agreement is used. The comment is input in text and a position where the comment is placed is designated. The indication representing agreement is selected from a seal or a signature, and a position where the indication is placed is designated.

As illustrated in FIG. 17, the optional function setting screen 3000 includes a file preview field 3001, a text selection button 3002, a seal selection button 3003, and a signature selection button 3004.

In the file preview field 3001, a preview of the contents of the document relating to the contract for which the optional function is set is displayed. The text selection button 3002 is a button for adding a text such as a comment to the document relating to the contract. The seal selection button 3003 is a button for adding a field for a seal to the document relating to the contract. The signature selection button 3004 is a button for adding a field for a signature to the document relating to the contract.

After pressing the text selection button 3002, the seal selection button 3003, or the signature selection button 3004, the user presses a position where a text, a seal, or a signature corresponding to the selected processing of the optional function is to be added in the file preview field 3001. Then, the optional function setting unit 313 transmits a request for setting the optional function representing the contents of the selected processing to the screen information providing unit 21.

Returning to FIG. 16, the description continues. In S2113, the screen information providing unit 21 receives the request for setting the optional function from the optional function setting unit 313. Then, the screen information providing unit 21 transfers the request for setting the optional function to the contract management unit 22. The request for setting the optional function includes the document ID and the option information.

In S2212, the contract processing unit 222 included in the contract management unit 22 receives the request for setting the optional function from the screen information providing unit 21. Then, the contract processing unit 222 stores the option information included in the request for setting the optional function in the option information storage unit 204.

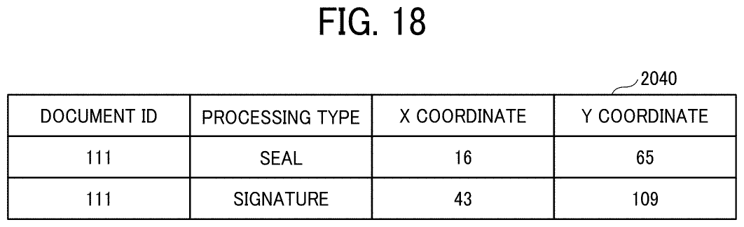

Here, a description is given of the option information table stored in the option information storage unit 204 in detail with reference to FIG. 18. FIG. 18 is a table illustrating an example of an option information table 2040 according to the present embodiment.

As illustrated in FIG. 18, the option information table 2040 according to the present embodiment includes, as data items, “DOCUMENT ID,” “PROCESSING TYPE,” “X COORDINATE.” and “Y COORDINATE.” The processing type is information indicating the type of processing of the optional function to be used. The X coordinate and the Y coordinate are information indicating a position where the processing of the optional function is displayed.

The option information table 2040 illustrated in FIG. 18 indicates that a field for a seal is added at a position indicated by the X coordinate of “16” and the Y coordinate of “65,” and a field for a signature is added at a position indicated by the X coordinate of “43” and the Y coordinate of “109” for a document having the document ID of “111.”

The user can freely determine whether to use an optional function. Accordingly, no option information is generated for a document for which no optional function is used.

Returning to FIG. 16, the description continues. In S3013, the browser 31 included in the operator terminal 30-1 transmits a request for transmitting a contract conclusion request to the screen information providing unit 21 in response to an operation by the operator. The request for transmitting the contract conclusion request includes the document ID for identifying the document relating to the contract.

In S2114, the screen information providing unit 21 receives the request for transmitting the contract conclusion request from the browser 31. Then, the screen information providing unit 21 transfers the request for transmitting the contract conclusion request to the contract management unit 22.

In S2203, the contract transmission unit 223 included in the contract management unit 22 receives the request for transmitting the contract conclusion request from the screen information providing unit 21. The contract transmission unit 223 generates identification information indicating a position of the document specified by the document ID included in the request for transmitting the contract conclusion request. Then, the contract transmission unit 223 transmits a request for concluding the contract including the identification information indicating the position of the document to the business partner terminal 40.

The following can be seen by comparing the processing method when the automatic transmission is not performed and the processing method when the automatic transmission is performed. In the case where the optional function is not used, the contract is automatically transmitted to the business partner. On the other hand, in the case where the optional function is used, the contract needs to be manually transmitted to the business partner. In other words, there is a trade-off relationship between use of an optional function and the automatic transmission.

In a case where a document requiring an optional function relating to a contract and another document not requiring any optional function relating to the same contract exist, the processing method for not performing the automatic transmission needs to be adopted for processing the contract. In this case, the another document not requiring any optional function also needs to be manually transmitted, which impairs convenience.

Information Processing Method in First Embodiment

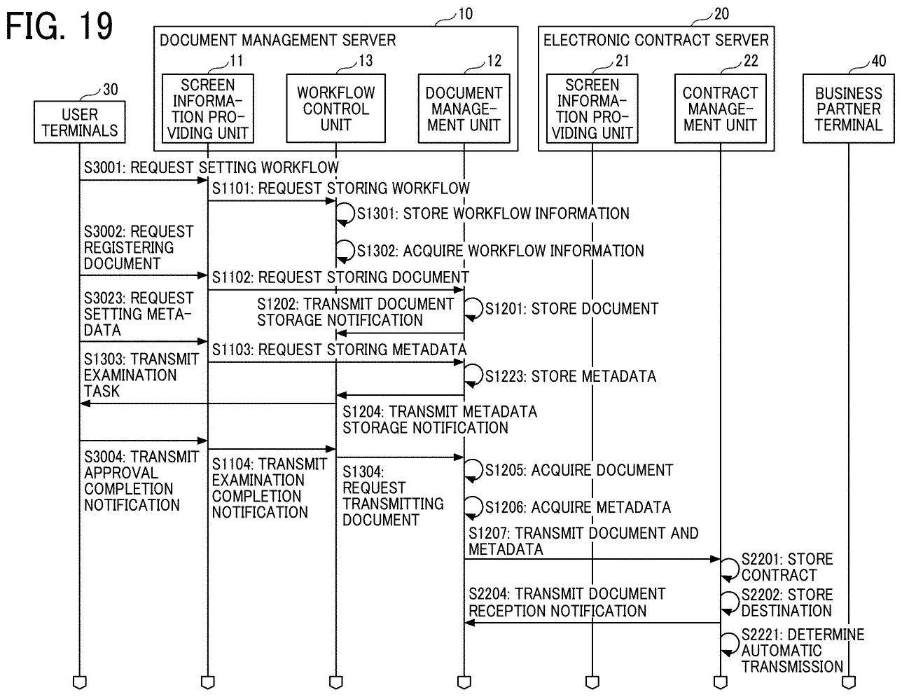

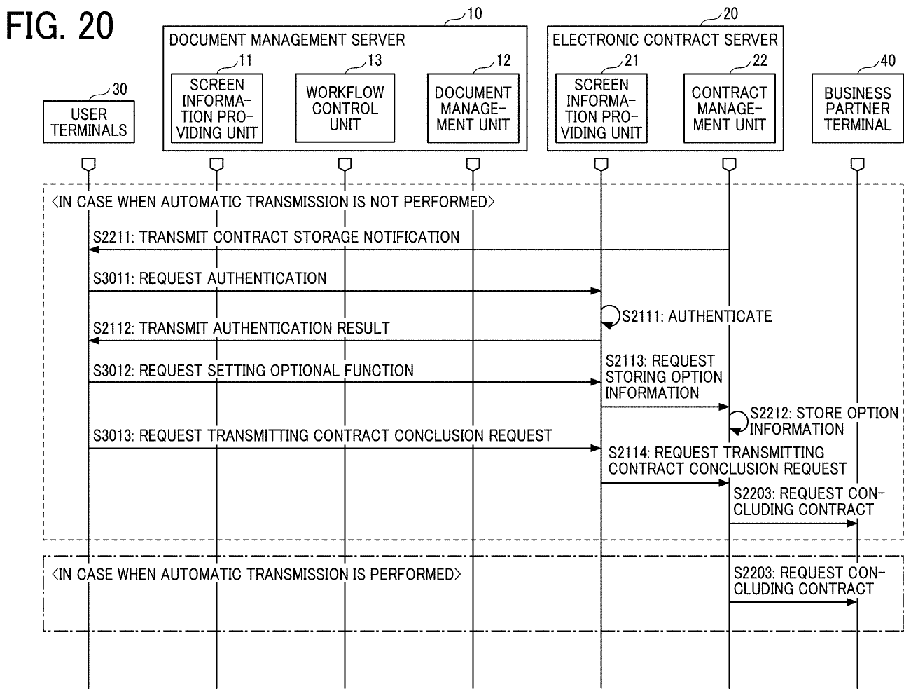

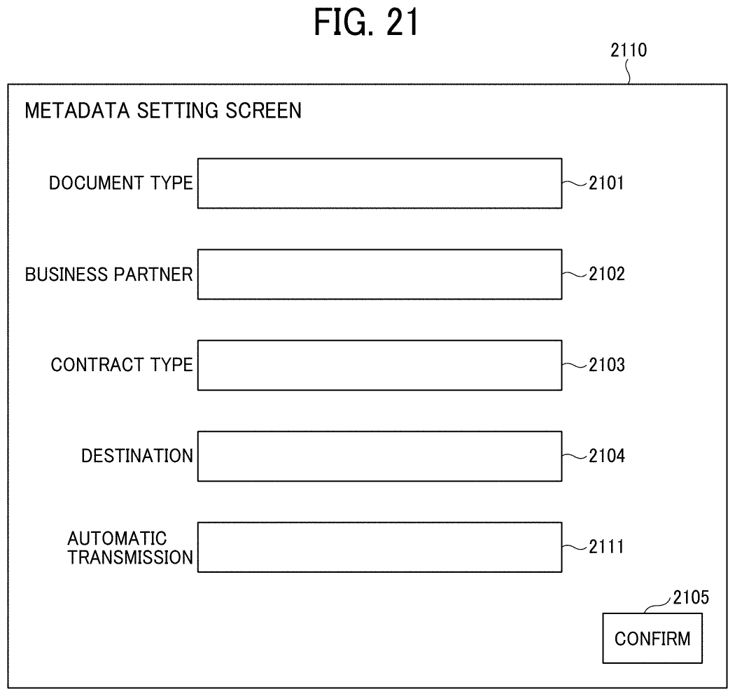

A description is given of an example of an information processing method according to the first embodiment executed by the information processing system 1 with reference to FIGS. 19 and 20. FIGS. 19 and 20 are sequence charts each illustrating the information processing method according to the present embodiment. The processing method illustrated in FIG. 20 follows the processing method illustrated in FIG. 19.

The processing of S3001 to S1202 is the same as the processing when the automatic transmission is performed (illustrated in FIG. 8).

In S3023, the document registration unit 312 included in the operator terminal 30-1 selects one document from documents stored in the document storage unit 102 in response to an operation by the operator. Then, the document registration unit 312 displays a metadata setting screen for setting metadata for the selected document.

Here, a description is given of the metadata setting screen in detail with reference to FIG. 21. FIG. 21 is a view illustrating an example of a metadata setting screen 2110 according to the present embodiment.

As illustrated in FIG. 21, the metadata setting screen 2110 according to the present embodiment includes the document type input field 2101, the business partner input field 2102, the contract type input field 2103, the destination input field 2104, and the confirm button 2105 similar to the metadata setting screen 2100 illustrated in FIG. 13, and further includes an automatic transmission input field 2111.

The automatic transmission input field 2111 receives an input of control information indicating whether the automatic transmission is performed in the electronic contract server 20. In other words, the metadata setting screen 2110 according to the preset embodiment differs from the metadata setting screen 2100 illustrated in FIG. 13 in that the automatic transmission input field 2111 is added.

When the user presses the confirm button 2105, the document registration unit 312 transmits a request for setting metadata to the screen information providing unit 11. The request for setting the metadata indicates the contents input to the document type input field 2101, the business partner input field 2102, the contract type input field 2103, the destination input field 2104, and the automatic transmission input field 2111.

Returning to FIG. 19, the description continues. In S1223, the metadata setting unit 122 included in the document management unit 12 receives the request for setting the metadata from the screen information providing unit 11. Then, the metadata setting unit 122 stores the metadata in the metadata storage unit 103 in response to the request for setting the metadata.

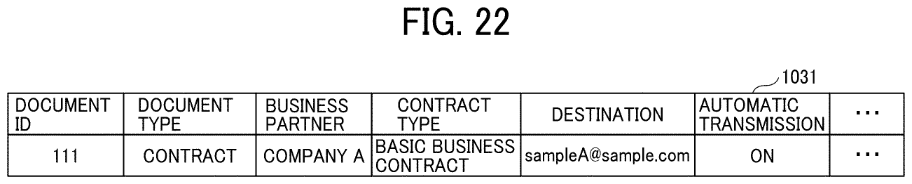

Here, a description is given of the metadata table stored in the metadata storage unit 103 in detail with reference to FIG. 22. FIG. 22 is a view illustrating an example of a metadata table 1031 according to the present embodiment.

As illustrated in FIG. 22, the metadata table 1031 according to the present embodiment includes, as data items, “DOCUMENT ID.” “DOCUMENT TYPE,” “BUSINESS PARTNER,” “CONTRACT TYPE,” and “DESTINATION” similar to the metadata table 1030 illustrated in FIG. 21, and further includes “AUTOMATIC TRANSMISSION.”

The content input to the automatic transmission input field 2111 is set as the value of the data item “AUTOMATIC TRANSMISSION.” In other words, the metadata table 1031 according to the preset embodiment differs from the metadata table 1030 illustrated in FIG. 14 in that the control information indicating whether the automatic transmission is performed is added.

Returning to FIG. 19, the description continues. The processing of S1204 to S2204 is the same as the processing when the automatic transmission is performed (illustrated in FIG. 8).

In S2221, the contract processing unit 222 included in the contract management unit 22 determines the contents of processing (e.g., whether automatic transmission is performed) on the contract based on the control information included in the metadata received from the document transmission unit 123.

Referring now to FIG. 20, the description continues. In a case where the control information included in the metadata indicates that the automatic transmission is not performed, the contract management unit 22 advances the processing to S2211. In other words, the contract processing unit 222 included in the contract management unit 22 transmits a contract storage notification indicating completion of storage of the contract to the operator terminal 30-1.

Thereafter, similar to the processing method when the automatic transmission is not performed (illustrated in FIG. 16), the processing of S3011 to S2203 is executed.

On the other hand, in a case where the control information included in the metadata indicates that the automatic transmission is performed, the contract management unit 22 advances the processing to S2203. In other words, the contract transmission unit 223 included in the contract management unit 22 transmits a request for concluding the contract to the business partner terminal 40.

According to the information processing system 1 of the first embodiment, the document management server 10 transmits the metadata including the control information indicating whether the automatic transmission is performed together with the document to the electronic contract server 20. The electronic contract server 20 determines whether the automatic transmission is performed based on the control information included in the metadata received together with the document and determines the contents of the processing on the contract.

Thus, in a case where the control information indicates that the automatic transmission is performed, the user can control the electronic contract server 20 to transmit the document to the business partner after completion of the processing in the document management server 10 without operating the electronic contract server 20.

In a case where the control information indicates that the automatic transmission is not performed, the user logs in to the electronic contract server 20 as usual after the completion of the processing in the document management server 10. Then, the user manually transmits the document to the business partner after using the optional function as necessary.

In other words, according to the information processing system 1 of the present embodiment, the document management server 10 can control the contents of the processing to be executed on the contract by the electronic contract server 20.

### Second Embodiment

In the first embodiment, the control information is set in the metadata by the user directly inputting the control information indicating whether the automatic transmission is performed. In a second embodiment, a rule for determining whether the automatic transmission is performed is set in advance, and control information generated according to the rule is to be set in the metadata.

Functional Configuration of Each Apparatus Included in Information Processing System

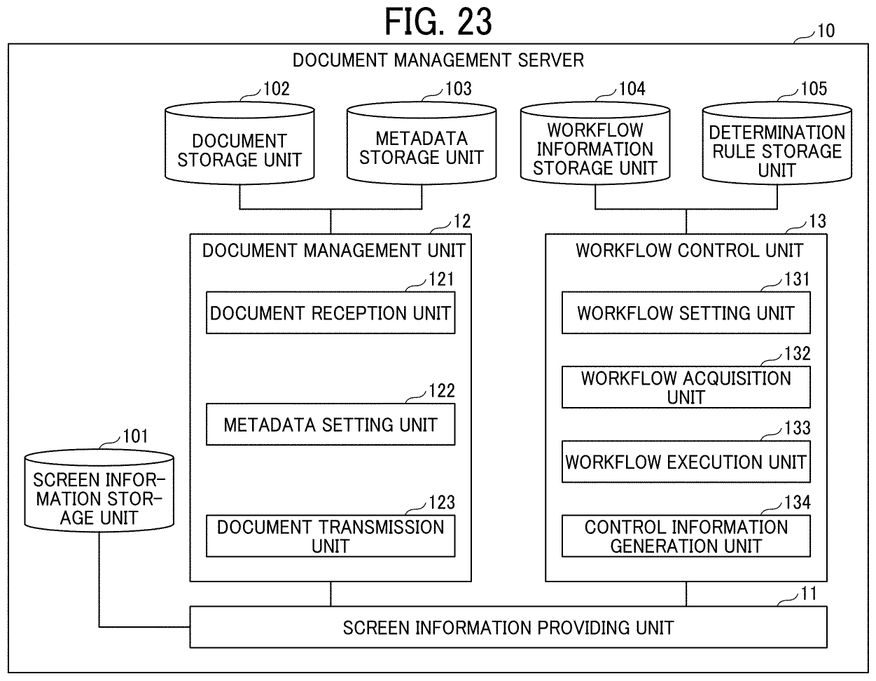

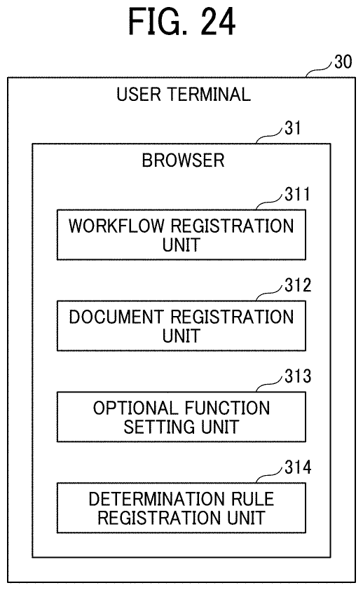

A description is given of a functional configuration of the information processing system 1 according to the second embodiment with reference to FIGS. 23 to 24.

Functional Configuration of Document Management Server

FIG. 23 is a block diagram illustrating an example of a functional configuration of the document management server 10 according to the preset embodiment. As illustrated in FIG. 23, the document management server 10 according to the present embodiment includes the screen information providing unit 11, the document management unit 12, the workflow control unit 13, the screen information storage unit 101, the document storage unit 102, the metadata storage unit 103, and the workflow information storage unit 104 similar to the first embodiment, and further includes a determination rule storage unit 105. The workflow control unit 13 according to the present embodiment includes the workflow setting unit 131, the workflow acquisition unit 132, and the workflow execution unit 133 similar to the first embodiment, and further includes a control information generation unit 134.

The control information generation unit 134 generates control information based on the metadata associated with the document according to determination rule information stored in the determination rule storage unit 105.

The determination rule storage unit 105 stores the determination rule information received from the user terminal 30. The determination rule information is stored in a determination rule information table stored in the determination rule storage unit 105.

Functional Configuration of User Terminal

FIG. 24 is a block diagram illustrating an example of a functional configuration of the user terminal 30 according to the present embodiment. As illustrated in FIG. 24, the user terminal 30 according to the present embodiment includes the browser 31 similar to the first embodiment. The browser 31 includes the workflow registration unit 311, the document registration unit 312, and the optional function setting unit 313 similar to the first embodiment, and further includes a determination rule registration unit 314.

The determination rule registration unit 314 transmits a request for setting the determination rule to the document management server 10 in response to an operation by the user on a determination rule setting screen. The determination rule setting screen is a screen for inputting a determination rule to be registered in the document management server 10. Details of the determination rule setting screen are described later.

Information Processing Method in Second Embodiment

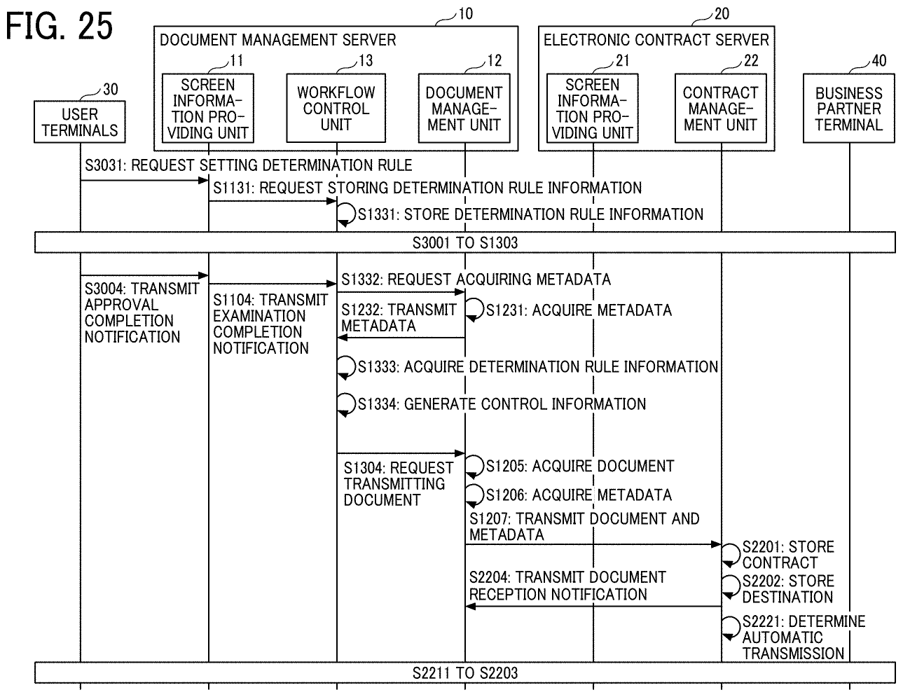

A description is given of an example of an information processing method according to the second embodiment executed by the information processing system 1 with reference to FIG. 25. FIG. 25 is a sequence chart illustrating the information processing method according to the present embodiment.

In S3031, the browser 31 included in the user terminal 30 requests a determination rule setting screen (specifically, screen information representing thereof) from the screen information providing unit 11 included in the document management server 10 in response to a user operation. The screen information providing unit 11 transmits screen information representing the determination rule setting screen stored in the screen information storage unit 101 to the browser 31. The browser 31 displays the determination rule setting screen based on the screen information received from the screen information providing unit 11. As a result, the determination rule registration unit 314 is activated.

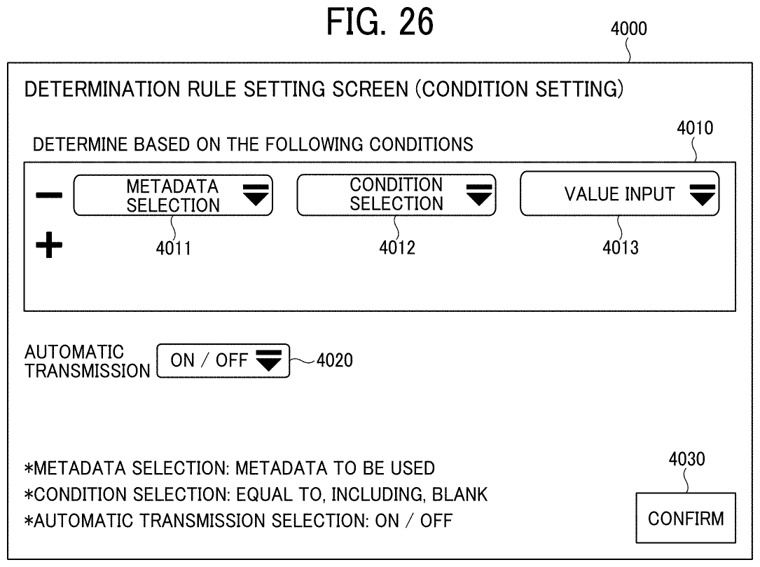

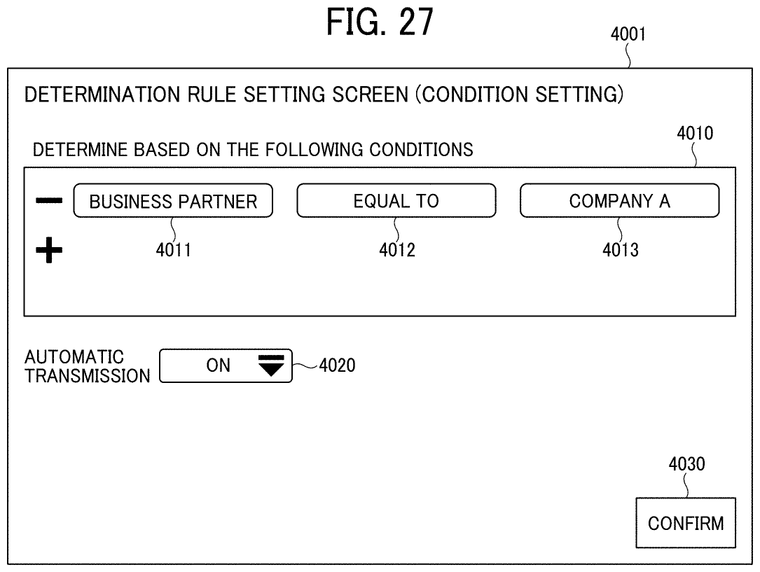

Here, a description is given of the determination rule setting screen in detail with reference to FIGS. 26 and 27. FIG. 26 is a view illustrating an example of a determination rule setting screen 4000 according to the present embodiment. FIG. 27 is a view illustrating an example of a determination rule setting screen 4001 in a state where a specific determination rule is input.

As illustrated in FIG. 26, the determination rule setting screen 4000 according to the present embodiment includes a condition setting field 4010, an automatic transmission setting field 4020, and a confirm button 4030. The condition setting field 4010 includes a metadata selection field 4011, a condition selection field 4012, and a value input field 4013.

The condition setting field 4010 receives an input of a condition used for the determination rule. The metadata selection field 4011 receives an input of metadata used for determination. The condition selection field 4012 receives an input of a condition (“EQUAL TO,” “INCLUDING,” or “BLANK”) used for determination. The value input field 4013 receives an input of a value used for determination. The automatic transmission setting field 4020 receives an input of control information indicating whether the automatic transmission is performed in a case where the condition input to the condition setting field 4010 is satisfied.

The condition setting field 4010 can receive inputs of a plurality of conditions. In inputting the plurality of conditions, information indicating a logical addition (OR) or a logical conjunction (AND) can be set for each condition. For example, assuming that logical conjunctions are set for all of the plurality of conditions, control information representing the content input to the automatic transmission setting field 4020 is generated when all of the plurality of conditions are satisfied. For another example, assuming that logical additions are set for all of the plurality of conditions, control information representing the content input to the automatic transmission setting field 4020 is generated when any one of the plurality of conditions is satisfied.

When the user presses the confirm button 4030, the determination rule registration unit 314 transmits a request for setting the determination rule indicating the contents input to the condition selection field 4012 and the automatic transmission setting field 4020 to the screen information providing unit 11.

As illustrated in FIG. 27, in the determination rule setting screen 4001 according to the present embodiment, “BUSINESS PARTNER” is input to the metadata selection field 4011, “EQUAL TO” is input to the condition selection field 4012, “COMPANY A” is input to the value input field 4013, and “ON” is input to the automatic transmission setting field 4020. It is assumed that the user presses the confirm button 4030 on the determination rule setting screen 4001. In a case where the business partner included in the metadata is equal to the company A, control information indicating that the automatic transmission is performed is generated and a request for setting the determination rule including the control information indicating that the automatic transmission is performed is transmitted. In a case where the business partner included in the metadata is other than the company A, control information indicating that the automatic transmission is not performed is generated and a request for setting the determination rule including the control information indicating that the automatic transmission is not performed is transmitted.

Returning to FIG. 25, the description continues. In S1131, the screen information providing unit 11 receives the request for setting the determination rule from the determination rule registration unit 314. Then, the screen information providing unit 11 transmits a request for storing determination rule information representing the setting contents of the determination rule to the workflow control unit 13 in response to the request for setting the determination rule.

In S1331, the workflow setting unit 131 included in the workflow control unit 13 receives the request for storing the determination rule information from the screen information providing unit 11. Then, the workflow setting unit 131 stores the determination rule information in the determination rule storage unit 105 in response to the request for storing the determination rule information.

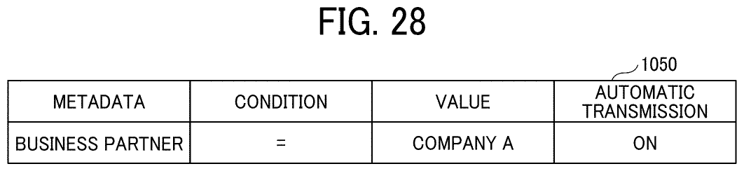

Here, a description is given of the determination rule information table stored in the determination rule storage unit 105 in detail with reference to FIG. 28. FIG. 28 is a table illustrating an example of a determination rule information table 1050 according to the present embodiment.

As illustrated in FIG. 28, the determination rule information table 1050 according to the present embodiment includes, as data items, “METADATA,” “CONDITION,” “VALUE,” and “AUTOMATIC TRANSMISSION.”

The content input to the metadata selection field 4011 is set as the value of the data item “METADATA.” The content input to the condition selection field 4012 is set as the value of the data item “CONDITION.” The content input to the value input field 4013 is set as the value of the data item “VALUE.” The content input to the automatic transmission setting field 4020 is set as the value of the data item “AUTOMATIC TRANSMISSION.”

The determination rule information table 1050 illustrated in FIG. 28 represents that control information indicating that the automatic transmission is performed is generated in a case where the business partner included in the metadata is equal to the company A and control information indicating that the automatic transmission is not performed is generated in a case where the business partner included in the metadata is other than the company A.

Thereafter, the same processing as the processing of S3001 to S1303 in the processing method according to the first embodiment illustrated in FIG. 19 is executed.

In S3004, the browser 31 included in the approver terminal 30-2 transmits an approval completion notification of the document specified by the document ID included in the examination task to the screen information providing unit 11 in response to an operation by the approver.

In S1104, the screen information providing unit 11 transmits an examination completion notification to the workflow control unit 13 in response to the approval completion notification of the document received from the approver terminal 30-2.

In S1332, the control information generation unit 134 included in the workflow control unit 13 transmits a request for acquiring the metadata to the document management unit 12. The request for acquiring the metadata includes the document ID included in the examination completion notification.

In S1231, the document transmission unit 123 included in the document management unit 12 acquires the metadata associated with the document specified by the document ID included in the request for acquiring the metadata from the metadata storage unit 103.

In S1232, the document transmission unit 123 transmits the metadata to the control information generation unit 134.

In S1333, the control information generation unit 134 receives the metadata from the document transmission unit 123. Then, the control information generation unit 134 acquires the determination rule information stored in the determination rule storage unit 105.

In S1334, the control information generation unit 134 generates control information indicating whether the automatic transmission is performed based on the metadata received from the document transmission unit 123 according to the determination rule information acquired from the determination rule storage unit 105. Then, the control information generation unit 134 transmits the document ID and the control information to the workflow execution unit 133.

In S1304, in response to receiving the document ID and the control information from the control information generation unit 134, the workflow execution unit 133 transmits, to the document management unit 12, a request for transmitting the document specified by the document ID. The request for transmitting the document includes the document ID and the control information.

In S1205, the document transmission unit 123 included in the document management unit 12 receives the request for transmitting the document from the workflow execution unit 133. Then, the document transmission unit 123 acquires, from the document storage unit 102, the document specified by the document ID included in the request for transmitting the document.

In S1206, the document transmission unit 123 acquires, from the metadata storage unit 103, the metadata associated with the document specified by the document ID included in the request for transmitting the document. Here, the document transmission unit 123 adds an item of the automatic transmission to the metadata acquired from the metadata storage unit 103 to set the control information included in the document transmission request.

In S1207, the document transmission unit 123 transmits the document acquired in S1205 and the metadata acquired in S1206 as a pair to the electronic contract server 20.

The processing of S2201 to S2221 is the same as the processing according to the first embodiment illustrated in FIG. 19.

Thereafter, in a case where the control information included in the metadata indicates that the automatic transmission is not performed, the processing of S2211 to S2203 in the processing method according to the first embodiment illustrated in FIG. 20 is executed. On the other hand, in a case where the control information included in the metadata indicates that the automatic transmission is performed, the processing of S2203 in the processing method according to the first embodiment illustrated in FIG. 20 is executed.

The information processing system 1 according to the second embodiment generates the control information indicating whether the automatic transmission is performed based on the information such as the type of document set in the metadata according to the determination rule set in advance by the user.

Thus, the user does not have to determine whether the automatic transmission should be performed. Instead, whether the automatic transmission is performed is automatically and reliably determined. This configuration can prevent a situation where the user erroneously transmits a contract that originally requires designation of a position for a signature or the like to the business partner without designating the position for the signature or the like, or a situation where a contract that originally does not require designation of a position for a signature or the like is not transmitted since the user forgets to manually transmit the contract to the business partner.

In each of the above-described embodiments, the document management server 10 is an example of an information processing apparatus. The electronic contract server 20 is an example of another information processing apparatus. The document is an example of electronic data. The metadata is an example of a user setting. The metadata setting unit 122 is an example of a reception unit. The document transmission unit 123 is an example of a transmission unit. The control information generating unit 134 is an example of a generation unit. The processing of S1203 executed by the metadata setting unit 122 is an example of a reception procedure. The processing of S1207 executed by the document transmission unit 123 is an example of a transmission procedure.

Each of the functions of the above-described embodiment may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The apparatuses or devices described in the above-described embodiments are merely one example of the plural computing environments that implement the embodiments disclosed herein. In some embodiments, each of the document management server 10 and the electronic contract server 20 includes a plurality of computing devices, such as a server cluster. The plurality of computing devices communicates with one another through any type of communication link including, for example, a network or a shared memory, and performs the operations described in the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

One aspect of the present disclosure provides an information processing method performed by a computer. The method includes receiving electronic data and a user setting relating to the electronic data from a user terminal and transmitting information on a content of processing to be performed by an information processing apparatus and the electronic data via a network to the information processing apparatus. The content of processing is determined based on the user setting.

1. An information processing apparatus comprising circuitry configured to:
receive electronic data and a user setting relating to the electronic data from a user terminal; and
transmit information on a content of processing to be performed by another information processing apparatus and the electronic data via a network to the another information processing apparatus, the content of processing being determined based on the user setting.

2. The information processing apparatus according to claim 1, wherein:
the circuitry is configured to:
transmit, to the user terminal, screen information representing a screen for allowing a user to input control information representing the content of the processing as the user setting; and
transmit the control information representing the content of processing received from the user terminal to the another information processing apparatus.

3. The information processing apparatus according to claim 1, wherein:
the circuitry is further configured to:
transmit screen information representing a screen for allowing the user to input attribute information of the electronic data to the user terminal;
apply a predetermined rule to the attribute information received from the user terminal to generate the control information representing the content of the processing as the user setting; and
transmit the control information to the another information processing apparatus.

4. The information processing apparatus according to claim 2, wherein:
the electronic data is associated with metadata received from the user terminal; and
the circuitry is configured to transmit the metadata including the control information to the another information processing apparatus.

5. The information processing apparatus according to claim 4, wherein:
the control information indicates whether the another information processing apparatus automatically transmits the electronic data to a predetermined destination.

6. An information processing system comprising:
a first information processing apparatus; and
a second information processing apparatus configured to communicate with the first information processing apparatus via a network,
the first information processing apparatus including first circuitry configured to:
receive electronic data and a user setting relating to the electronic data from a user terminal; and
transmit information on a content of processing to be performed by the second information processing apparatus and the electronic data to the second information processing apparatus, the content of processing being determined based on the user setting,
the second information processing apparatus including second circuitry configured to:
receive the content of the processing and the electronic data transmitted from the first information processing apparatus; and
process the electronic data in accordance with the content of the processing.

7. A non-transitory recording medium storing a plurality of program codes which, when executed by one or more processors, causes the processors to perform a method, the method comprising:
receiving electronic data and a user setting relating to the electronic data from a user terminal; and
transmitting information on a content of processing to be performed by an information processing apparatus and the electronic data via a network to the information processing apparatus, the content of processing being determined based on the user setting.
